(19) United States
(12) Patent Application Publication
(10) Pub. No.: US 2020/0243210 A1
(43) Pub. Date: Jul. 30, 2020

(54) SYSTEM, APPARATUS AND METHOD FOR PRODUCING GALLIUM RADIOISOTOPES ON PARTICLE ACCELERATORS USING SOLID TARGETS AND GA-68 COMPOSITION PRODUCED BY SAME

(71) Applicants: Stefan Zeisler, Vancouver (CA); Joel Oscar Olsson Kumlin, Vancouver (CA)

(72) Inventors: Stefan Zeisler, Vancouver (CA); Joel Oscar Olsson Kumlin, Vancouver (CA)

(21) Appl. No.: 16/635,027

(22) PCT Filed: Jul. 30, 2018
(86) PCT No.: PCT/CA2018/000146

§ 371 Date: Jan. 29, 2020

Related U.S. Application Data
(60) Provisional application No. 62/538,954, filed on Jul. 31, 2017.

(51) Int. Cl. G21G 1/10; H05H 6/00; G21G 1/00

(52) U.S. Cl. CPC G21G 1/10; G21G 2001/0021; G21G 1/001; H05H 6/00

(57) ABSTRACT

The present invention is directed to a system, apparatus, and method for producing gallium radioisotopes on particle accelerators using solid targets and a Ga-68 composition produced by this method. The solid target assembly apparatus has a metal disc and a zinc portion on the top of the disc. The apparatus is made by preparing a quantity of zinc, depositing it onto a metal disc, melting the zinc, and allowing it to cool and solidify. The disc surface may be prepared before applying zinc to it in order to facilitate bonding between the substrate and the zinc. Ga-68 is produced by placing the apparatus in a cyclotron target irradiation station, irradiating it, separating it from the irradiated Zn, and collecting and storing the separated Ga-68. The Ga-68 composition has the following quotient of activity quantity ratios: Ga-67/Ga-68 less than 1, and Ga-67/Ga-68 less than 1.

### PRIORITY CLAIM

This Utility patent application claims the benefit of U.S. Provisional Application No. 62/538,954 filed on Jul. 31, 2017, the entirety of which is incorporated herein.

### BACKGROUND OF THE INVENTION

### 1. Field of the Invention

The present invention relates generally to the field of radiopharmaceutical production. More particularly, it relates to systems, apparatus, and methods of producing gallium radioisotopes from solid zinc targets irradiated by an accelerated particle beam. It also relates to a gallium-68 composition produced by these methods.

### 2. Background of the Invention

Gallium-68 (Ga-68) is a positron emitting radioactive isotope of gallium that is desirable for medical use. Ga-68 possesses two desirable properties for medical use, a short half-life (t½: 68 min) and a high branching ratio for positron emission (β+%: 89%). Ga-68 tracers may be used for brain, heart, bone, lung or tumor imaging. Specifically, Ga-68 is useful for the production of radiolabeled compounds used as tracer molecules in positron emission tomography (PET) imaging techniques. It forms stable complexes with chelating agents, for example DOTA (1,4,7,10-tetraazacyclododecane-1,4,7,10-tetraacetic acid), NOTA (1,4,7-triazacyclononane-1,4,7-triacetic acid) and HBED-CC (N,N′-bis-[2-hydroxy-5-(carboxyethyl)benzyl]ethylenediamine-N,N′-diaceticacid). 68Ge/Ga-68 generators may deliver Ga-68, but this Ga-68 activity decreases over time due to the decay of the parent nuclide 68Ge (t½: 271 d). Potential breakthrough of Ge-68 with eluted gallium is an undesirable possible consequence of making Ga-68 using 68Ge/Ga-68 generators. Cyclotron production of Ga-68 provides a way to meet a large demand for Ga-68 while eliminating the possibility of 68Ge breakthrough during the production process.

### SUMMARY OF THE INVENTION

The present invention is directed to a solid target assembly apparatus for making gallium isotopes, such as Ga-68. The assembly has a target backing portion and a Zn portion on top of it.

The present invention is also directed to method of making a solid target assembly apparatus. In an embodiment, this is done by preparing a quantity of Zn, depositing the Zn onto a substrate, heating the Zn until at least some of it begins to melt, and (actively or passively) allowing the Zn to cool off and solidify. In an embodiment, this is done by providing a metal disc with front and rear surfaces and some Zn, preparing the top surface of the disc, applying the Zn onto this surface to form the stacked target apparatus, and bonding the quantity of Zn to the surface of the disc (e.g. by applying heat to it).

The present invention is also directed to a solid target assembly apparatus made according to any of the methods discussed above.

The present invention is also directed to a method of producing Ga-68 by cyclotron by:
providing any of the target assemblies above, a cyclotron that is capable of producing proton beams of at least 5 MeV and has a target irradiation station,
placing the assembly into the irradiation station, irradiating it for a predetermined period of time,
transferring it to a chemical processing station, chemically separating Ga-68 from the Zn, and collecting and storing the separated Ga-68.

The present invention is also directed Ga-68 composition made according to the any of the methods discussed above.

### BRIEF DESCRIPTION OF DRAWINGS

FIG. 1 shows a perspective view of an embodiment of the target assembly apparatus.

FIG. 2 shows a perspective view of an embodiment of the apparatus of FIG. 1 with no recess, no zinc.

FIG. 3 shows a perspective view of an embodiment of the apparatus of FIG. 1 with a recess, no zinc.

FIG. 4 shows a front view of the embodiment of the apparatus of FIG. 1.

FIG. 5 shows a front view of the embodiment of the apparatus of FIG. 2.

FIG. 6 shows a front view of the embodiment of the apparatus of FIG. 3.

FIG. 7 shows a rear view of the embodiments of the apparatus of FIGS. 1-3.

FIG. 8 shows a side view of the embodiment of the apparatus of FIGS. 1-3.

FIG. 9 shows a front view of the embodiment of the apparatus of FIG. 2 and section line A-A.

FIG. 10 shows a front view of the embodiment of the apparatus of FIG. 3 and section line B-B.

FIG. 11 shows a sectional view of an embodiment of the apparatus of FIG. 2 taken along section line A-A.

FIG. 12 shows a sectional view of an embodiment of the apparatus of FIG. 2 taken along section line A-A.

FIG. 13 shows a sectional view of an embodiment of the apparatus of FIG. 3 taken along section line B-B.

FIG. 14 shows a sectional view of an embodiment of the apparatus of FIG. 3 taken along section line B-B.

FIG. 15 shows a sectional view of an embodiment of the apparatus of FIG. 3 taken along section line B-B.

FIG. 16 shows a front view of an embodiment of the apparatus of FIG. 1.

FIG. 17 shows a front view of an embodiment of the apparatus of FIG. 1.

FIG. 18 shows a front view of an embodiment of the apparatus of FIG. 1.

FIG. 19 shows an exploded view of an embodiment of the apparatus of FIGS. 1, 2, 11-12.

FIG. 20 shows an exploded view of an embodiment of the apparatus of FIGS. 1, 3, 14-15.

FIG. 21 shows a flowchart of an embodiment of a method of making an aluminum and zinc target assembly apparatus.

FIG. 22 shows a flowchart of an embodiment of a method of making a Silver and Zinc target assembly apparatus.

FIG. 23 shows an embodiment of a method of making Ga-68 from an embodiment of the target assembly apparatus by cyclotron.

FIG. 24 shows an embodiment of a method of separating Ga-68 from an irradiated target assembly apparatus.

### DETAILED DESCRIPTION OF THE INVENTION

The present invention is directed to a system, apparatus, and method for producing gallium radioisotopes (e.g. Ga-68) from a non-radioactive isotope of zinc (e.g. Zn-68) on particle accelerators and a Ga-68 composition produced by this method.

In an embodiment, Ga-68 is produced in a cyclotron via the 68Zn(p,n)Ga-68 reaction in a solid target. The parent compound, zinc, for example Zn-68, a naturally occurring stable isotope of zinc, is deposited on a substrate that is irradiated with a proton beam. After irradiation, the target is dissolved in a strong acid solution to obtain a solution that is then purified to obtain Ga-68.

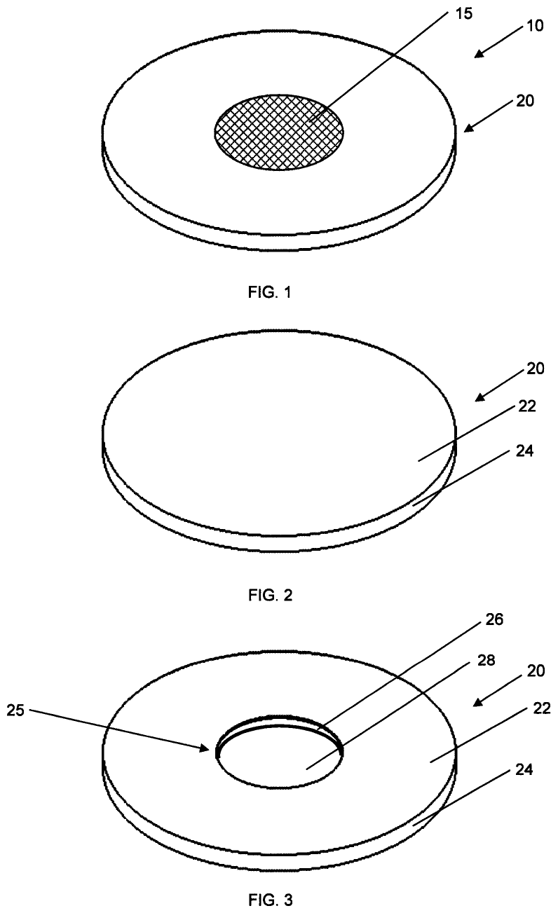

FIG. 1 shows a perspective view of an embodiment of the target assembly apparatus 10. In an embodiment, the apparatus 10 has a substrate (i.e. target backing portion) 20 and a zinc portion 15 disposed on top of the backing 20. FIG. 1 shows am embodiment of the apparatus 10 where the target backing 20 is a circular shaped metal disc with front and rear surfaces. The metal disc may be made of a material selected from the group consisting of Al, Ag, and Cu.

The zinc portion 15 is on the front surface of the target backing 20. In an embodiment, the zinc may be impregnated in the target backing material, but not substantially within it. In an embodiment, the zinc material mostly contains zinc Zn-68 (at least 90%), a stable (non-radioactive) isotope of zinc, and also has traces of other zinc isotopes, such as Zn-64, Zn-66, Zn-67, and/or Zn-70 and other elements, such as Al, As, Ca, Cd, Co, Cr, Cu, Fe, K, Mg, Mn, Na, Pb, Si, and/or Sn.

The target backing material may be made of chemically inert metals, such as the noble metals or the refractory metals, or any other material with a high thermal conductivity that is suitable for mechanical or other modification and bonds easily to zinc, such as silver, copper or aluminum. The backing material is of sufficient robustness to dissipate an exemplary proton beam current of at least approximately 10 μA and energy of approximately 15 MeV on a beam spot of approximately 10 mm diameter.

FIG. 2 shows a perspective view of an embodiment of the apparatus 10 of FIG. 1 (with no recess and no zinc). In an embodiment, the target backing 20 has front 22, rear (not shown), and side 24 surface and no recess.

FIG. 3 shows a perspective view of an embodiment of the apparatus 10 of FIG. 1 (with recess and no zinc). In an embodiment, the target backing 20 has a recess 25 in the front surface 22 of the backing for receiving and securing the zinc portion (not shown) in the apparatus 10. The recess 25 has a recess floor 28 and a side wall 26. In an embodiment where the target assembly has a recess, the Zn portion 15 is in the recess on top of the recess floor 28.

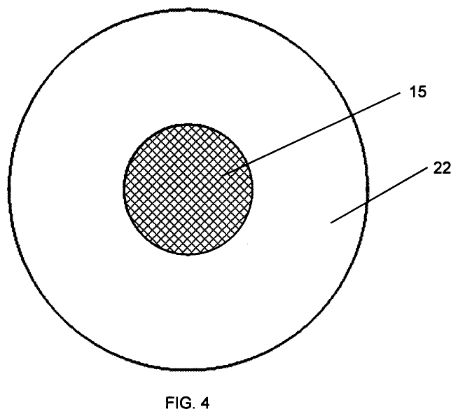

FIG. 4 shows a front view of the embodiment of the apparatus 10 of FIGS. 1-3 with the target backing 20 and a zinc portion 15. In the embodiment with no recess (FIG. 2), the zinc portion 15 sits on top of the backing's surface 22. In an embodiment with a recess 25 (FIG. 3), the zinc portion 15 sits within the recess 25.

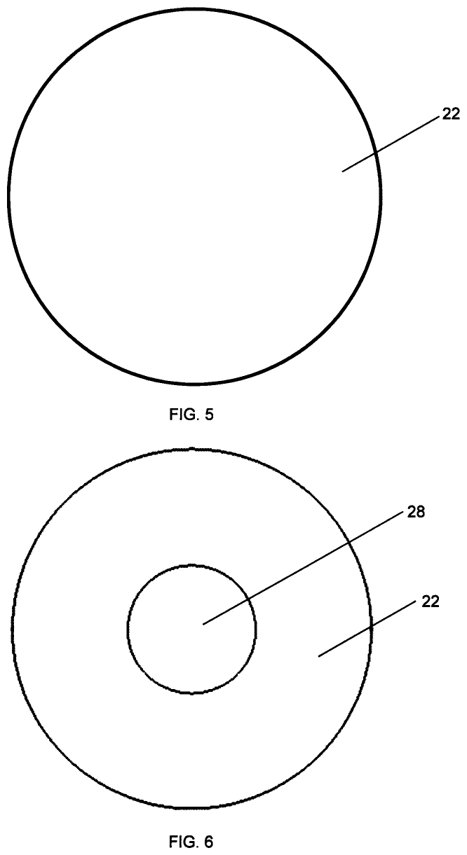

FIGS. 5 and 6 show front views of the embodiments of the apparatus 10 of FIGS. 2 and 3, respectively, with no zinc on the front surface 22 of the target backing 20. FIG. 6 shows an embodiment of the target backing 20 with a recess and recess floor 28 formed in the front surface 22 of the target backing 20.

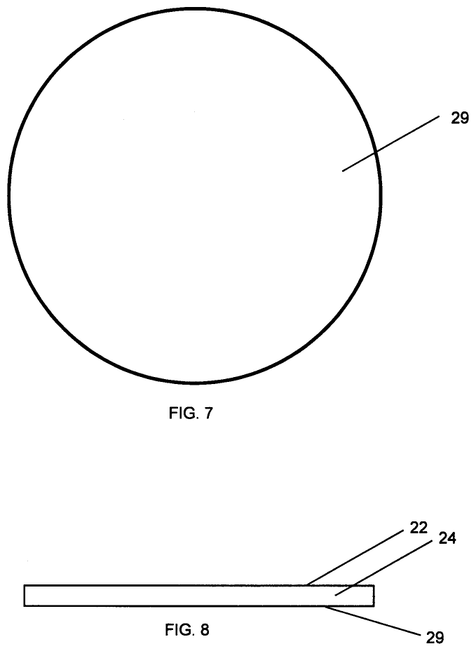

FIG. 7 shows a rear view of the embodiment of the apparatus 10 of FIG. 1 with the rear surface 29.

FIG. 8 shows a side view of the embodiment of the apparatus 10 of FIG. 1 with the front, side, and rear surfaces 22, 24, 29.

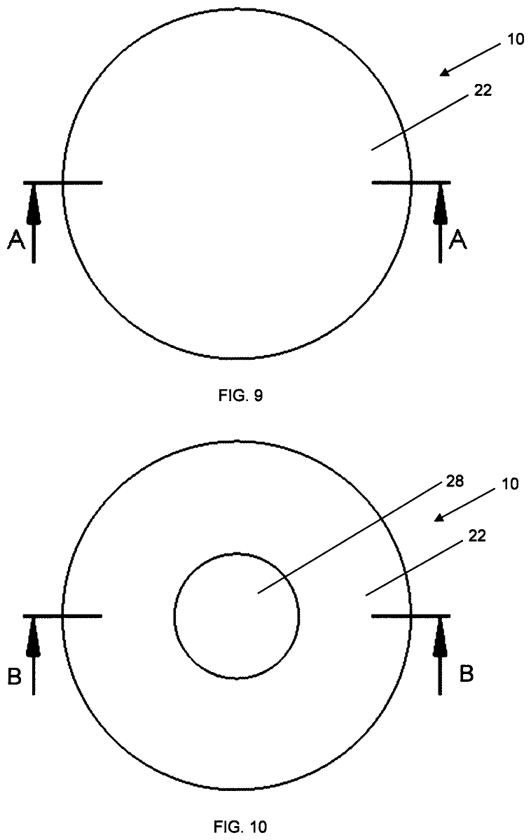

FIGS. 8-9 show side views of the embodiments of the apparatus (with or without zinc) with the side 24 and top 22 surfaces of the target backing. Referring to FIG. 8, in an embodiment, the top of the zinc portion may be below (not shown) or flush with (not shown) the front surface 22 of the target backing 20. Referring to FIG. 9, in in embodiment, the top of the zinc portion 15 may rise above the front surface 22 of the zinc portion 20.

FIG. 9 shows a front view of the embodiment of the target backing 20 of the apparatus 10 of FIG. 2 with section line A-A taken along the diameter of target backing 20. FIG. 9 shows am embodiment with no zinc.

FIG. 10 shows a front view of the embodiment of the target backing 20 of the apparatus 10 of FIG. 3 and section line B-B taken along the diameter of the target backing 20. The target backing 20 has a recess with a recess floor 28. FIG. 9 shows am embodiment with no zinc.

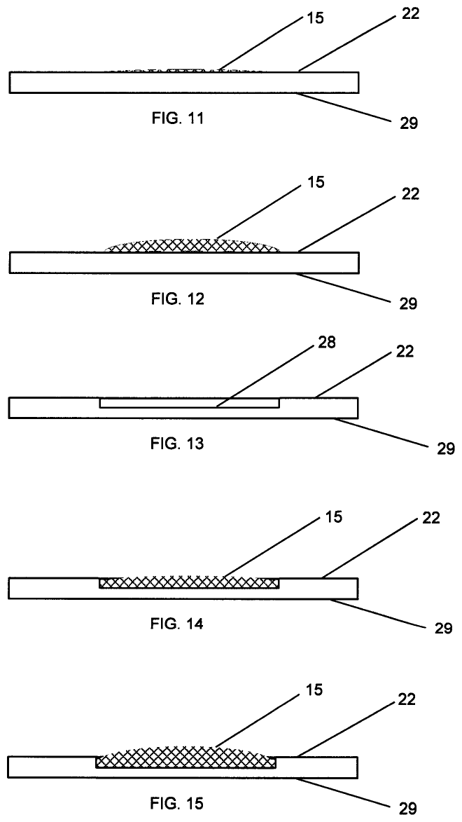

FIGS. 11-12 show sectional views of embodiments of the apparatus 10 taken along section line A-A. In an embodiment, a zinc portion 15 sits on the front surface 22 of the target backing 20 of the apparatus 10. The size and shape of the zinc portion 15 may vary. It must be thick and dense enough to dissipate the intensity of a proton beam that strikes the zinc during irradiation. In an embodiment, the zinc portion 15 may be a thin layer (FIG. 11) or a thick layer (FIG. 12) that protrudes out from the front surface 22 of the target backing 20.

FIGS. 13-15 show sectional views of embodiments of the apparatus 10 taken along section line B-B. FIG. 13 shows a cross section of the target backing 20 with the recess formed in the front surface 22. As discussed above, the size and shape of the zinc portion 15 may vary and must be suitable to withstand and dissipate the intensity of a proton beam that strikes the zinc during irradiation. In an embodiment, the zinc portion 15 may fill the recess and be flush with the front surface 22 (FIG. 14) or may overfill the recess and rise above the front surface 22 (FIG. 15).

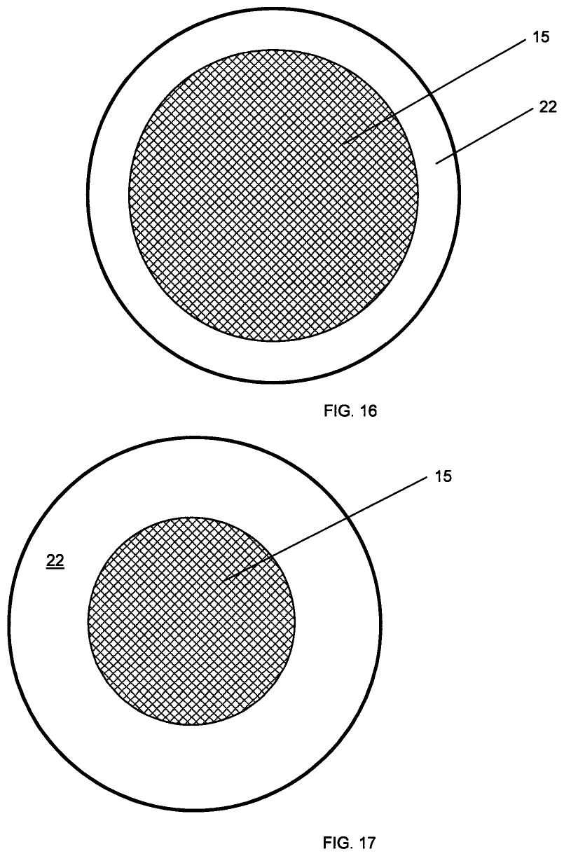

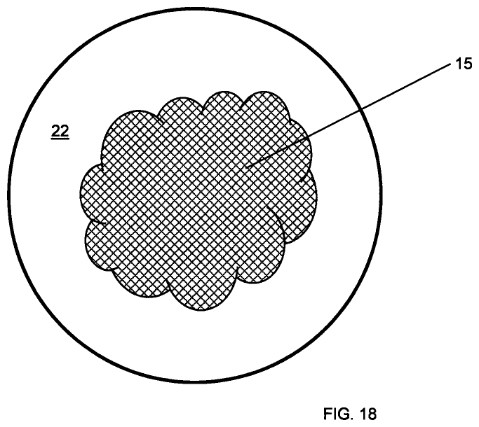

FIGS. 16-18 show front views of an embodiment of the apparatus of FIG. 1 with various sized and shaped zinc portions 15.

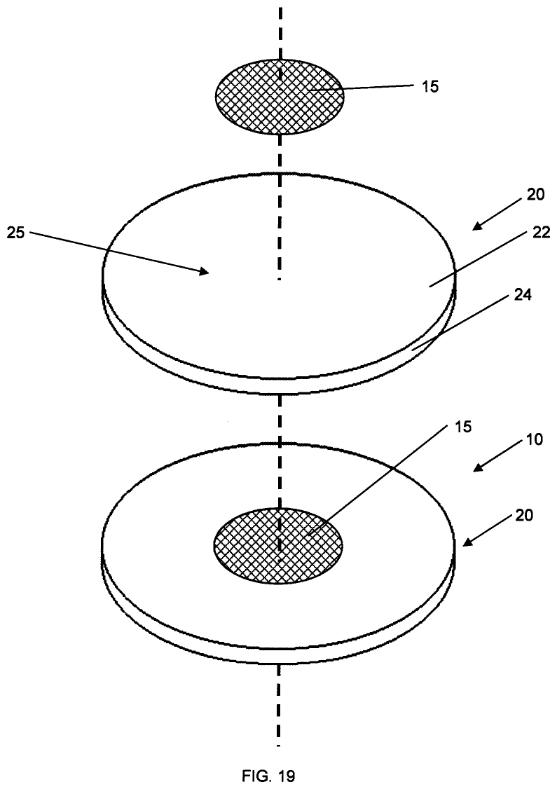

FIG. 19 shows an exploded view of an embodiment of the apparatus of FIGS. 1, 2, 11-12 with the zinc portion 15 on the smooth, planar surface of the target backing 20.

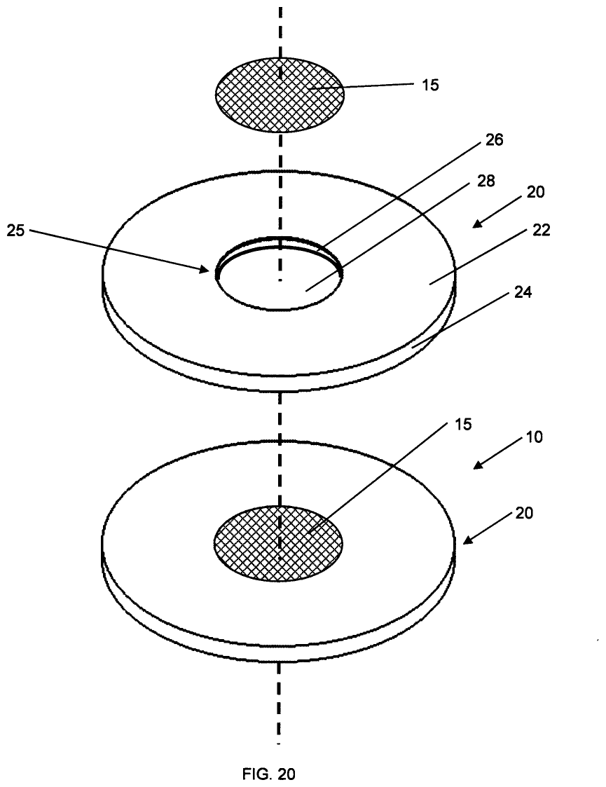

FIG. 20 shows an exploded view of an embodiment of the apparatus of FIGS. 1, 3, 14-15 with the zinc portion 15 within the recess 25 of the target backing 20.

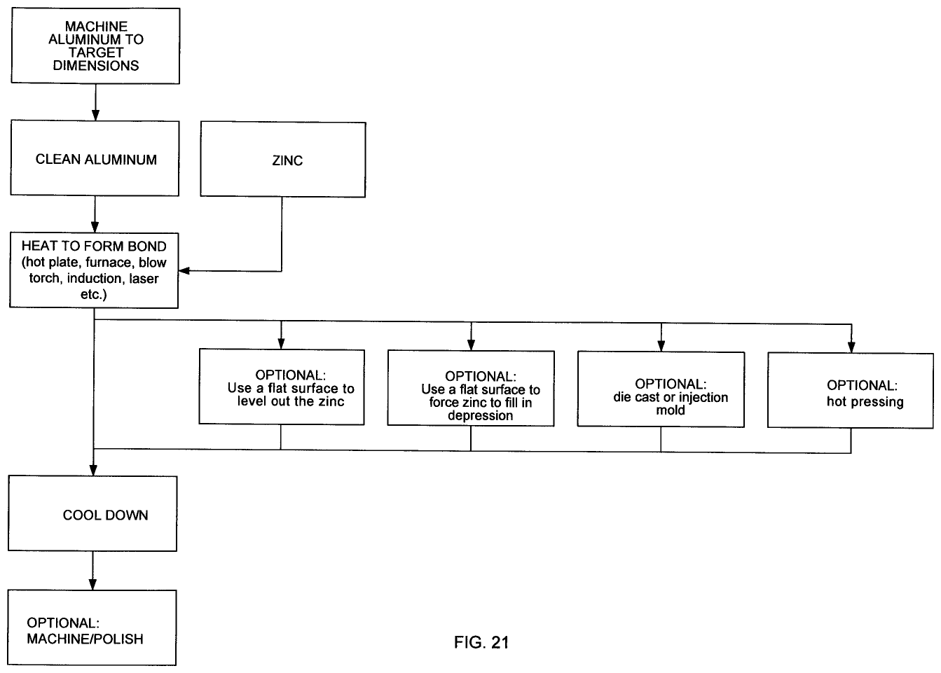

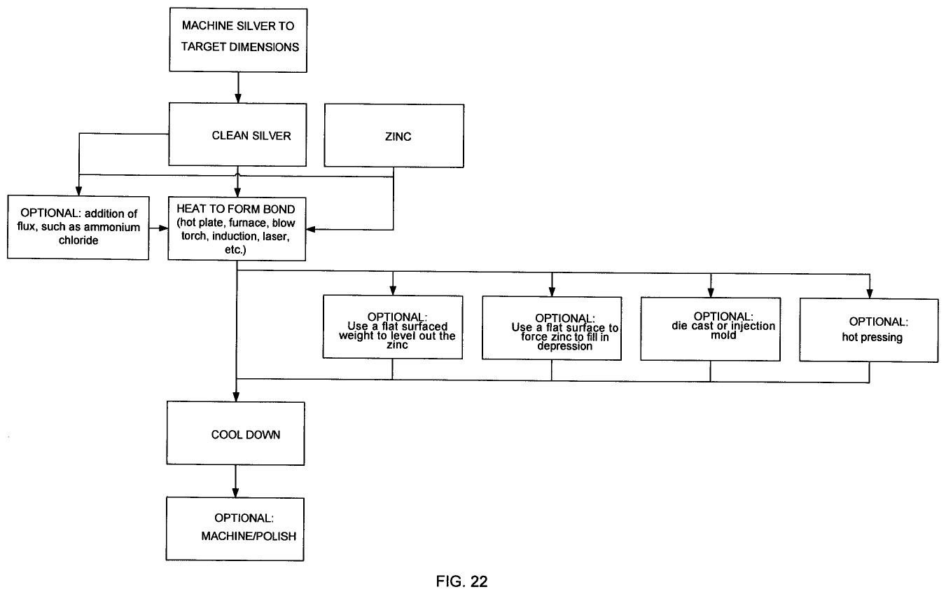

The present invention is also directed to method of making a solid target assembly apparatus. FIGS. 21 and 22 show flowcharts of embodiments of method of making the apparatus 10 of FIG. 1, where the target backing 20 is aluminum (FIG. 19) and silver (FIG. 20), respectively. In an embodiment, a method of making a solid target assembly apparatus comprises the steps of:
preparing a quantity of Zn,
depositing the quantity of Zn onto a substrate to form the apparatus,
heating the Zn to at least 419.5° C. until at least some of it begins to melt, and
ceasing heating the Zn (i.e. by removing it from the heat source, or removing the heat source from it, etc.) to allow the Zn to solidify.

In an embodiment, a method of making a solid target assembly apparatus comprises the steps of:
providing a metal disc with front and rear surfaces and some Zn,
preparing the top surface of the disc,
applying the Zn onto this surface to form the stacked target apparatus, and
bonding the quantity of Zn to the surface of the disc (e.g. by applying heat to it).

In an embodiment, bonding the Zn to the surface of the disc may be done by heating the zinc until it at least partially melts (e.g. heating it to at least 419.5° C. for up to 30 minutes) and then allowing it to cool to ambient. In an embodiment, bonding the Zn to the surface of the disc may be done by in an oxygen-free or low oxygen environment.

The target assembly is heated using any suitable heat source such as a hot plate, furnace, blow torch, induction heating, laser, arc melting, or a combination thereof.

In an embodiment, the target assembly discussed above may be made according to any of the methods discussed above.

### Methods of Making the Target Assembly Apparatus

First, the target backings 20 (a/k/a target backings) are made. They may be various sizes or shapes. In an embodiment, they are smooth, solid, planar discs with or without a recess.

Next, the bonding surfaces are prepared for bonding the target backing 20 with the zinc portion 15 to form the target assembly apparatus 10. Many metal bonding methods, such as soldering or diffusion bonding, require preparation of the metal surfaces of materials to be bonded. In an embodiment, the front surface 22 of the target backing 20 is prepared as a bonding surface for bonding to the zinc portion 15. Some example preparation techniques include, but are not limited to mechanically cleaning, degreasing, etching, roughening (e.g. using an abrasive such as sand paper), polishing, laser engraving, and/or mechanically indenting the surface. Adhesion may occur independent of the surface finish.

Also, many metals exposed to air become coated with an oxide layer, which may compromise bonding between the target backing 20 and the zinc portion 15. This oxide layer may be removed from the target backing 20 mechanically (e.g. via sanding) or chemically (e.g. via etching with chemicals) before bonding. Alternatively, plasma etching or other techniques may be applied. Oxide layers may also be removed during the bonding process by using corrosive fluxes.

As discussed above, in an embodiment, the target backing 20 of the apparatus 10 may contain silver, aluminum, or copper. Commercial aluminum may be naturally coated with a relatively thick oxide layer that protects the metal from further corrosion. In an embodiment where the target backing 20 contains aluminum, the front surface 22 of a backing 20 containing aluminum may be prepared by removing this oxide layer mechanically or chemically (e.g. using mineral acids or bases, such as alkali hydroxide or alkali carbonates). In this embodiment, if the aluminum backing is in air or any oxygen rich environment, the cleaned surface may then be rinsed and used for target assembly apparatus fabrication as soon as possible before re-oxidation occurs. Alternatively, the preparation and fabrication steps may be done in an oxygen free environment in order to avoid re-oxidation. In an embodiment, the bonding surface of the target backing 20 containing aluminum may be prepared and cleaned using an aqueous zincate solution containing 10% sodium hydroxide (w/w), 2% zinc oxide (w/w), and 0.2% sodium cyanide (w/w). In an embodiment, the zincate process may be applied at least twice, with acid etching and rinsing steps in between. An exemplary double zincate method would be: Cleaning and degreasing; sodium hydroxide etching; rinsing; etching with half-concentrated nitric acid; rinsing; zincate; rinse; etching with half-concentrated nitric acid; rinse; zincate; rinse. In an embodiment where the target backing 20 contains silver, the target backing 20 may not oxidize as rapidly as aluminum or other metals. Bonding surface preparation of a target backing 20 containing silver may be prepared by cleaning it mechanically (e.g. with and abrasive such as sandpaper) and/or chemically (e.g. removing a silver oxide layer with acid such as sulfuric acid). In an embodiment, the target backing 28 may also be made of copper.

Next, the zinc is deposited onto the prepared surface of the metal disc 20. The zinc may be in a variety of forms such as a solid disc, powder, compressed powder, compacted powder, a foil, shavings or granules that are loose or compacted into a thin pellet, or the like. The zinc is applied directly to the metal disc 20, for example in accordance with any of the application methods discussed below. In an embodiment, the zinc may be applied to the metal disc 20 by plasma spraying or a similar technique.

After this, heat is applied to one or both components in order to bond the components to one another. The zinc should be heated until it melts (i.e. to a temperature of at least its melting point) to achieve a strong bond between the two components. In an embodiment method using a powerful heat source, the zinc may be heated briefly (e.g. a few seconds). When heated in ambient air, heating should be stopped shortly after the zinc melts. In an embodiment where the target backing contains aluminum, the zinc should not be melted for more than approximately 30 minutes.

In an embodiment, the heat source is a hotplate, large industrial solder table, or a blow torch. The zinc is applied on the front surface of the metal disc 20 (either on the front surface 22 or within a recess). The zinc and metal disc assembly is then heated (e.g. placed on a hotplate, within the flame of a blow torch, in a furnace, using induction heating, laser, arc melting, a combination thereof, etc.) and heated to a predetermined temperature and/or for a predetermined period of time until the zinc melts. The assembly is removed from the heat and allowed to cool down (actively or passively) to ambient in order to allow the zinc to solidify.

In an embodiment, pressure is applied to the assembly during or immediately after heating to facilitate bonding between the components. For example, a weight made out of an inert material that does not bond to zinc (e.g. quartz) is placed on top of the zinc before heating. The small force caused by this additional weight aids in the bonding process.

Other heating sources and methods, such as metallurgical or brazing furnace, induction heating, or hot pressing, may be used.

In an embodiment, the bonding process is performed in an oxygen free environment (or substantially oxygen free environment), for example in an inert gas atmosphere or in a vacuum.

As this process is similar to soldering, the flowing of the zinc and its adhesion may be improved by using a flux material (e.g. a paste which contains e.g. a corrosive substance, some binder and other chemicals). In an embodiment, the process may include pre-coating the backing with a minute quantity of ammonium chloride before melting the zinc onto the backing. Ammonium chloride decomposes upon heating, liberating hydrochloric acid, which aids in the removal of oxide films on both the zinc and the backing, thus improving the diffusion bond. Unused flux may be removed after the soldering.

In an embodiment, the target assembly may be fabricated using a die casting process. Liquid zinc may be applied to the target backing 20 through a heated injection system (e.g. using a heated Pasteur pipette) directly onto the target backing (pre-heated or at ambient temperature). In an embodiment, the zinc may be laser melted onto the disc.

### Target Assembly Irradiation

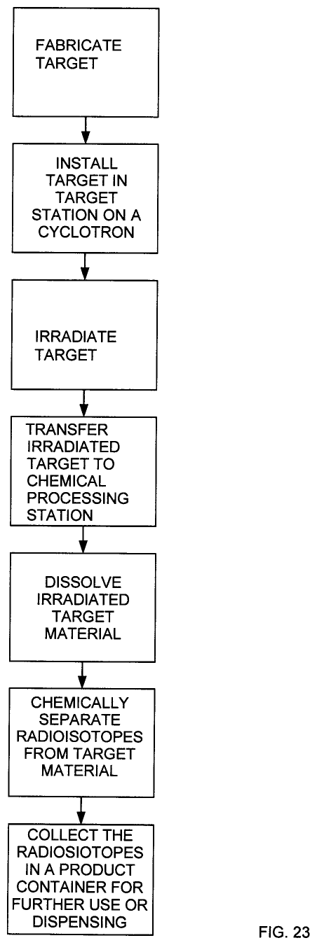

FIG. 23 shows an embodiment of a method of making Ga-68 via proton bombardment of the zinc target assembly apparatus by cyclotron.

After fabricating the targets assembly apparatus 10, it is placed into a target station in a cyclotron and irradiated for a predetermined period of time. The assembly 10 is bombarded with a proton beam having a predetermined energy level and beam current. In an embodiment, a method of producing Ga-68 by cyclotron comprises the steps of:
providing any of the solid target assemblies discussed above, a cyclotron capable of
producing proton beams of at least 12.7 MeV, and has a target irradiation station,
placing the assembly into the irradiation station,
irradiating the assembly for a predetermined period of time,
transferring the irradiated apparatus from the irradiation station to a chemical processing station,
chemically separating Ga-68 from the Zn on the irradiated assembly, and
collecting and storing the separated Ga-68.

In an exemplary embodiment, the target assembly 10 is irradiated with a proton beam having a current of up to 100 μA, beam energy of no more than 12.7 MeV, and a beam spot of approximately 10 mm diameter. In an embodiment, the apparatus 10 is irradiated for at least 5 minutes and no more than approximately hours.

### Radiochemical Dissolution, Separation, and Purification

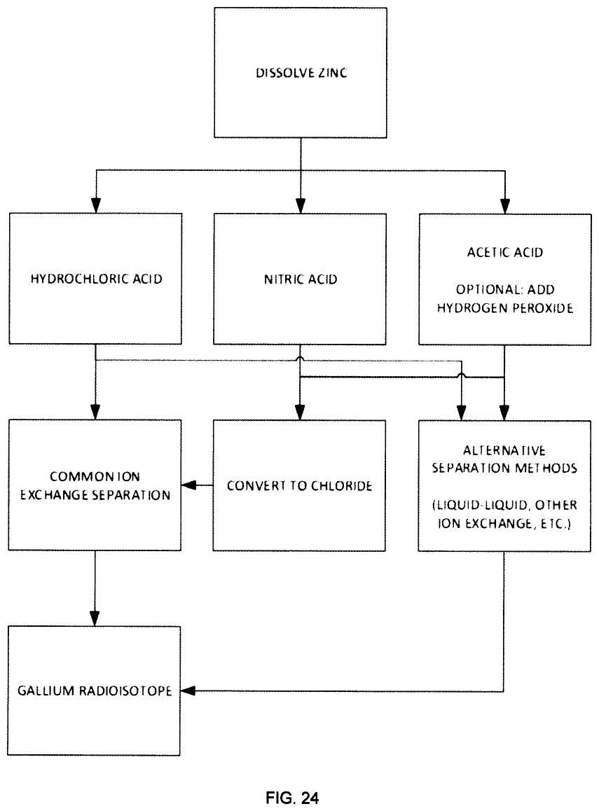

FIG. 24 shows an embodiment of a method of separating Ga-68 from an irradiated target assembly apparatus.

In addition to producing the desired Ga-68 isotope, irradiation of the zinc target also produces other isotopes such as Ga-64, Ga-66, Ga-67, and Ga-70. These other radioisotopes decay over time (i.e. 2 minutes-3 days). After irradiation, the Ga-68 that forms in irradiated zinc target material must be separated chemically from the irradiated target.

A number of chemical separation procedures for gallium-zinc separations exist. Applying these protocols to an irradiated zinc target to isolate Ga-68 will result in the isolation of Ga-68 with unique isotope ratios over time after the end of bombardment.

In an embodiment, where the target backing is silver or another noble metal, a purification method based on ion exchange chromatography in strong hydrochloric acid to dissolve the zinc and perform a standard purification protocol may be used.

Silver does not dissolve remarkably in hydrochloric acid due to the formation of insoluble silver chloride on the surface of the silver backing, whereas zinc and radio-gallium are rapidly dissolved. The resulting solution may be processed immediately in an ion exchange separation.

In an embodiment, a variation of this method may be used in which thermal diffusion is used to help Ga-68 migrate to the surface of the zinc layer 15 on the target assembly 10, which is then etched with a small amount of a suitable acid to recover a large fraction of Ga-68 while minimizing the quantity of zinc that needs to be dissolved and then separated. Further purification of Ga-68 may be achieved by liquid-liquid extraction.

In an embodiment where the target backing 20 contains aluminum, hydrochloric acid may be used but it dissolves both zinc and aluminum. A high concentration of aluminum in the solution may affect the separation chemistry, thus leading to lower yield and/or lower purity or reactivity of the Ga-68 product. For example, dissolving a 200 mg zinc pellet on a 4.0 g aluminum target disc by immersion in 12N HCl resulted in a zinc chloride solution contained approximately 15 mg of aluminum.

In an embodiment, zinc may be dissolved from a target disc containing aluminum using acetic or nitric acid. In an embodiment of a zinc dissolution method using acetic acid, the dissolution may be expedited by adding a small quantity of an oxidizing agent, such as hydrogen peroxide, and/or by applying heat. The resulting acetate solution may be evaporated and taken up in hydrochloric acid for subsequent standard ion exchange separation. Alternatively, purification may be achieved via cation exchange in ammonia containing solution. The dissolution of zinc in acetic acid proceeds rather slowly (e.g. >20 minutes for a 200 mg zinc pellet), unless the solution is heated to near boiling. The resulting solution contains only trace amounts of aluminum. In an embodiment of a zinc dissolution method using nitric acid, the nitric acid selectively dissolves zinc while the oxidizing properties of nitric acid increase the thickness of the natural oxide layer on metallic aluminum, thus protecting it from attack by the acid. The dissolution of zinc proceeds rapidly, and a wide range of concentrations may be used.

For example, in 8N nitric acid a 10 mm diameter, 200 mg zinc pellet dissolves in approximately 1-2 minutes. Concentrated nitric acid dissolved a similar pellet in less than one minute. In ˜2N HNO3, the dissolution is complete in ≤6 minutes. The resulting nitrate solution may be evaporated to dryness and taken up in hydrochloric acid for standard ion exchange separation.

In this method, in a 35 mm diameter target, aluminum may be dissolved concomitantly from a ˜2.5 gram backing in the range of 0-1.5 mg (0.06%), which may not affect the subsequent Ga-68 purification. The higher the acid concentration, the less aluminum was dissolved.

The aluminum content may be further reduced by not exposing the entire area of the target backing to nitric acid, for example, only the zinc layer on the front surface of the metal disc.

Nitric acid dissolution proceeds much faster than acetic acid dissolution, and is therefore desirable with Ga-68 separation because of the relatively short half-life of Ga-68 (approximately 68 minutes).

### Ga-68 Composition of Matter

The present invention is also directed to a Ga-68 composition of matter made according to the any of the methods discussed above.

Material ratios after separation are determined from the isotope ratios at the end of bombardment, the efficacy of the chosen chemical purification process, and then accounting for decay that occurs for each isotope during the time required to conduct separation.

Methods of the invention can produce Ga-68 compositions that, after purification and following the end of bombardment, have the following quotient of activity ratios:
Ga-67/Ga-68 less than 1, and
Ga-66/Ga-68 less than 1.

The impurities present in a Ga-68 composition made from a proton irradiated zinc target depend on the chemical and isotopic composition of the zinc starting material. For example, if the zinc starting material were 100% pure Zn-68, the only expected impurity would be Ga-67 if the proton energy is above 12.7 MeV.

In an experimental example, where a target apparatus 10 with a zinc portion 15 containing the following materials
Zn-70: 0.02%
Zn-68: 99.26%
Zn-67: 0.61%
Zn-66: 0.10%
Zn-64: 0.01%
   is irradiated 31 minutes and 49 seconds with a proton beam at 13 MeV and 5 μA, at the end of bombardment, the target material contains the following radioisotopes:
Ga-68: 99.970%
Ga-67: 0.024%
Ga-66: 0.009%

The proportion of Zn-68 in the target material relative to other materials is directly related to the relative proportion of Ga-68 created in the target material post irradiation. In other words, the greater the percentage of Zn-68 in the target material pre-irradiation, the greater the percentage of Ga-68 in the target material post-irradiation.

Other irradiations yield different results, depending on the composition of the starting material and irradiation time. During irradiation Ga-68 nears saturation before Ga-66 and Ga-67 because the half-life of Ga-68 is shorter than the half-life of Ga-66 and Ga-67.

### PARTS LIST

target assembly apparatus 10
zinc portion 15
target backing 20
front surface 22 (of target backing)
side surface 24 (of target backing)
rear surface 29 (of target backing)
recess 25
side wall 26 (of recess)
recess floor 28

1. A solid target assembly apparatus comprising
a metal disc comprising front and rear surfaces, and
a Zn portion disposed on the top surface of the disc.

2. The apparatus of claim 1, wherein
the metal disc further comprises a recess in the top surface, the recess comprising a recess floor and a recess wall, and
the Zn portion is disposed on the recess floor within the recess

3. The apparatus of claim 1, wherein the metal disc comprises a material selected from the group consisting of Al, Ag, and Cu.

4. A method of making a solid target assembly apparatus comprising
preparing a quantity of Zn,
depositing the quantity of Zn onto a substrate to form the apparatus,
heating the quantity of Zn to at least 419.5° C. until a portion of the quantity of Zn begins to melt, and
ceasing heating the quantity of Zn to allow the quantity of Zn to solidify.

5. A method of making a solid target assembly apparatus comprising
providing
a metal disc comprising front and rear surfaces, and
a quantity of Zn
preparing the top surface of the disc,
applying the quantity of Zn onto the prepared top surface of the disc to form the apparatus, and
bonding the quantity of Zn to the surface of the disc.

6. The method of claim 5, wherein the step of bonding the Zn to the surface of the disc comprises
heating the apparatus to at least 419.5° C. for up to 30 minutes, and
allowing the apparatus to cool to ambient.

7. The method of claim 5, wherein the step of bonding the Zn to the surface of the disc comprises bonding the Zn to the surface of the disc in an oxygen-free or low oxygen environment.

8. The method of claim 6, wherein the step of heating the solid target assembly apparatus comprises heating the target assembly apparatus by hot plate, furnace, blow torch, induction heating, laser, arc melting, or a combination thereof.

9. The method of claim 5, wherein the step of bonding the Zn to the surface of the disc comprises
Increasing the temperate the solid target assembly apparatus from ambient to at least 419.5° C. to melt the Zn,
Decreasing the temperature of the solid target assembly apparatus to ambient to solidify the Zn.

10. The method of claim 5, further comprising applying a selective pressure to the solid target assembly apparatus for aiding the bonding between the quantity of Zn and the surface of the disc.

11. A solid target assembly apparatus made according to the method of claim 5.

12. A method of producing Ga-68 by cyclotron, the method comprising
providing
the solid target assembly apparatus of claim 11,
a cyclotron capable of producing proton beams, the cyclotron comprising a target irradiation station
placing the solid target assembly apparatus in the target irradiation station,
irradiating the solid target assembly apparatus,
transferring the irradiated solid target assembly apparatus from the target irradiation station to a chemical processing station,
chemically separating Ga-68 from the quantity of Zn on the irradiated solid target assembly apparatus,
collecting the separated Ga-68, and
storing the collected Ga-68.

13. A Ga-68 composition made according to the any of the methods of claims 4-12.

14. A Ga-68 composition comprising the following quotient of activity quantity ratios:
Ga-67/Ga-68 less than 1, and
Ga-67/Ga-68 less than 1.
wherein the quotient of activity quantity ratios are measured at the end of proton irradiation.

15. The Ga-68 composition of claim 14 comprising the following quotient of activity quantity ratios:
Ga-67/Ga-68 less than 0.0003 and
Ga-66/Ga-68 less than 0.0001.
wherein the quotient of activity quantity ratios are measured at the end of proton irradiation.
